(19) United States
(12) Patent Application Publication
(10) Pub. No.: US 2009/0159512 A1
(43) Pub. Date: Jun. 25, 2009

(54) Method and Apparatus for Separating Submerged Particles From a Fluid

(75) Inventor: Knut Brattested, Sandefjord (NO)

Correspondence Address: BIRCH STEWART KOLASCH & BIRCH, PO BOX 747, FALLS CHURCH, VA, 22040-0747, US

(73) Assignee: Brattested Engineering AS, Sandefjord (NO)

(21) Appl. No.: 12/086,130

(22) PCT Filed: Dec. 7, 2006
(86) PCT No.: PCT/NO2006/000472

§ 371 Date: Jun. 5, 2008

(30) Foreign Application Priority Data
Dec. 7, 2005 (NO) 2005 5790

(51) Int. Cl. B07C 5/16; B07C 5/34

(52) U.S. Cl. 209/645; 209/208

(57) ABSTRACT

Present invention relates to a method and apparatus for separating particles from a fluid; particles are dispersed in the fluid and consist of lighter particles with lower density than the bulk, and heavier particles with a density higher than the bulk, method comprises the following steps: feeding the particle containing fluid to a separation device, evenly distribute the fluid over at least parts of the cross-sectional area by flowing through a distribution device (12) in an inlet chamber (11) providing the particle containing fluid with a specific velocity and leading the fluid to one or more collecting surfaces (5, 9) coalesce the lighter particles on the collecting surface (5, 9) remove the coalesced lighter particles from the collecting surface (5, 9) remove the particle depleted fluid and the lighter coalesced particles in at least two separate streams (2, 3) optionally remove the heavier particles from the bottom of the separation device in at least one separate stream

### BACKGROUND

1. Field of Invention

The present invention relates to a method for separating particles from a fluid, said particles are dispersed in the fluid and consist of lighter particles with a lower density than the bulk of the fluid, and optionally heavier particles with a density higher than the bulk of the fluid. The invention further relates to an apparatus for separating submerged particles from a fluid, said particles comprises lighter particles with a density lower than the bulk of the fluid and optionally heavier particles with a density higher than the bulk of the fluid, said apparatus comprising a vessel with at least one inlet for the fluid to be separated, at least one outlet for particle depleted fluid, and at least one outlet for separated lighter particles and optionally at least one outlet for heavier particles.

2. Description of Prior Art

The present invention can be utilized in a wide range of applications and industries where there is a need to separate and extract submerged particles from a fluid. Some of these areas of application are listed in the description of operation. One of the more important applications is within the separation of oil from water.

During the process of producing oil or bringing oil to the surface there is also a significant amount of water being brought up from the reservoir. The amounts of water will vary from 10% to 90% of the total oil/water volume and increase as an oil field matures. This water is referred to as produced water.

The water is separated from the oil in several stages and is then either re-injected into the reservoir or discharged. Requirements for maximum oil-in-water content are regulated by local authorities and commonly set to 40 ppm. This limit is expected to be lowered as environmental awareness increases, better technology becomes available and the total volume of produced water increases due to maturing oil fields.

The total amount of oil being discharged through produced water is in 2005 estimated to be 2.1 million barrels. By 2010 the number is expected to be 3 million barrels per day. Estimation is based on produced water discharge volumes of 70 billion barrels/day in 2005 and 100 billion barrels/day in 2010. Existing methods for separation of oil particles from water includes the use of gas flotation, gravity and centrifugal forces. Equipment includes flotation vessels, horizontal and vertical induced gas flotation tanks, compact flotation tanks, centrifuges, cyclones etc.

The theory of induced gas flotation is that submerged particles such as oil will attach to the bubbles and rise to the surface. Upwards velocity varies with bubble size and is governed by Stoke's Equation. Once the particles are brought to the surface they will be skimmed or siphoned off and thus separated from the main fluid.

All these methods and the equipment involved have limitations as to how effective the process is, how reliable the process/equipment is and so on. Existing equipment also has considerable drawbacks when it comes to size, weight, complexity of installation and operation.

As an oil field matures the need for additional water processing equipment arises. Heavy and complex equipment is difficult to fit into existing production facilities. Available space has to be located, new pipelines have to be installed and access secured for maintenance and operation of the equipment.

Prior art such as EP 1 335 784 B1 and U.S. Pat. No. 6,749,757 are both vertical, compact flotation units. Gas is induced either upstream of the vessel or it is added to fluid being recycled in the unit. Based on the principles of Stoke's Equation the vessels require large volumes to achieve necessary retention time for the gas bubbles to reach the surface. Hence, the units are relatively large. The units have shown varying degrees of efficiency dependent on the type of water to be treated.

EP 1335784 B1 describes a compact flotation and degassing tank utilizing cyclonic motion. Gas and chemical injection is added to increase the effectiveness of the process. Most applications call for removal of oil beyond the capacity of one single unit. Additional oil removal capacity is then obtained by adding a second or third treatment unit, occupying additional deck space and adding to the cost of the installation.

U.S. Pat. No. 6,749,757 describes a compact flotation unit for separation of oil from produced water, also utilizing cyclonic motion. The unit is more complex than EP 1335784 B1, having more auxiliary equipment built into the design. A water and gas recycling loop is driven by a separate centrifugal pump and includes a set of gas eductors for each recycle nozzle. Water for the recycle loop is collected from the vessel's main water outlet, gas from the gas phase at the top of the vessel. Oil particles are collected by an oil bucket by raising the overall liquid level in the tank. A separate pump is used for discharge of the oil bucket's content. The unit has so far not proven to be very successful in the market. This is believed to be due to the unit's complex design and operation, expectations of relatively high maintenance cost as well as a large footprint and overall volume.

Other prior art include cyclonic flotation units such as described in U.S. Pat. Nos. 4,094,783 and 5,207,920.

Flotation units and induced gas flotation units examined include U.S. Pat. Nos. 3,797,203, 4,186,087, 4,364,833, 4,830,755, 5,011,597, 5,484,534, 5,584,995, 5,840,183 and 6,238,569.

Other prior art for separating submerged particles from a fluid include filter units described in U.S. Pat. Nos. 4,572,786 and 4,839,040.

A vessel including a vertical spiral baffle is disclosed in U.S. Pat. No. 4,425,239. Separators include U.S. Pat. No. 4,424,068, WO9900169 and WO9002593. Centrifuge for separation is disclosed in U.S. Pat. No. 2,816,490 and finally cyclones used for separation of particles from fluids are disclosed in EP 0522686 and EP0566432.

Prior art includes flotation tanks, induced gas flotation tanks (IGF) and compact flotation units (CFU).

Flotation is based on moving particles through the bulk fluid by use of gravity to a surface for collection and removal. Gas bubbles and chemicals are added to further enhance this process. Particles to be separated are small and will only attach to small bubbles and then rise to the surface. The rise velocity is determined by Stoke's Equation—smaller bubbles move slower than larger ones. The disadvantage of the flotation method having to utilize small bubbles is that it requires long residence times and thus large vessels.

The present invention uses controlled flow to move the particles with the fluid to a surface. All particles, regardless of size are moved to the collecting surface with the same velocity, namely that of the bulk fluid. Testing has shown that particles can be moved 10 to 100 times faster than the velocity provided by gravity and still the desired separation at the surface will be achieved. The method of the present invention can thus process large quantities of fluid without being dependent on residence time as required by flotation.

Other methods described in prior art and commonly used for separation of particles from a fluid are coalescing units and cyclonic motion units. In a plate coalescer unit the fluid with submerged particles is moving underneath inclined plates and particles that come in contact with the plate surface will coalesce and eventually float along the plate to a collection surface. Plate coalescer units are gravity based and work well for large particles, but will not handle small particles due to the fact that there is not enough rise time as the one pass through the plate pack is too short. Plate coalescer units are large installations and require frequent downtime for cleaning and maintenance. The present invention is not based on gravity to move the particles to a separating or coalescing surface and thus handles both large and small particles. The units are small and particles are removed on a continuous basis to accommodate for less maintenance.

The third common method described in prior art for separation of particles from a fluid is the use of cyclonic motion as seen in hydrocyclones and centrifuges. The disadvantages of these types of equipment are high energy consumption, high maintenance of moving parts and high capital cost. The present invention has no energy consumption, no moving parts, low maintenance and low capital cost.

To conclude, the main difference between the prior art and the present invention is that the separation or treatment capacity for the present invention is not determined or limited by gravity, but by how the flow is guided towards a surface for separation. The flow velocity for the present invention has to be below a critical value. The critical value is dependent on the relative difference in density between the submerged particles and the main fluid, but will typically be between 0.05 and 0.3 m/s. This velocity will always be higher than what can be achieved by gravity.

With the increased demand for treatment of water in the oil, process and other industries the method and apparatus as described by the present invention will help lower cost and thus make effective systems available to meet the future challenges of keeping the environment clean.

### OBJECTS AND ADVANTAGES

Accordingly, objects and advantages of the present invention are to provide a method and apparatus for separating submerged particles from a fluid:

(a) which has a higher treatment capacity

(b) which is more reliable than existing systems

(c) which has a low cost

(d) which requires little space and is easy to install

(e) which has a low weight

(f) which is safe and easy to operate

(g) which is easy to maintain and repair

(h) which is not dependent on auxiliary equipment or additives

(i) which is easy to expand

These and other objectives are achieved by a method for separating particles from a fluid, said particles are dispersed in the fluid and consist of lighter particles with a lower density than the bulk of the fluid, and optionally heavier particles with a density higher than the bulk of the fluid, said method comprises the following steps:

feeding the particle containing fluid to a separation device,

evenly distribute the fluid over at least parts of the cross-sectional area by flowing through a distribution device in an inlet chamber

providing the particle containing fluid with a specific velocity and leading the fluid to one or more collecting surfaces

coalesce the lighter particles on the collecting surface

remove the coalesced lighter particles from the collecting surface

remove the particle depleted fluid and the lighter coalesced particles in at least two separate streams

optionally remove the heavier particles from the bottom of the separation device in at least one separate stream

According to a preferred embodiment of the invention, the distribution device is a perforated plate or a perforated tube.

The collecting surface is preferably one or more solid surfaces, one or more gas/liquid interfaces or combinations thereof.

The specific velocity of the particle containing fluid is preferably in the range from 0.001 to 1 m/s relative to the collecting surface, more preferably 0.05 to 0.3 m/s.

Present invention also relates an apparatus for separating particles from a fluid, said particles comprises lighter particles with a density lower than the bulk of the fluid and optionally heavier particles with a density higher than the bulk of the fluid, said apparatus comprising a vessel with at least one for the fluid to be separated, at least one for particle depleted fluid, and at least one outlet for separated lighter particles and optionally at least one outlet for heavier particles; said

apparatus further comprises:
distribution device for distributing the fluid evenly over at least parts of the cross-sectional area,
one or more collecting surfaces for collecting and coalescing particles from the fluid.

Said distribution device preferably comprises a plate with through going apertures, a perforated tube or one or more flow directing tubes, through which the fluid passes.

The collecting surfaces are preferably one or more solid surfaces, one or more gas/liquid interfaces or combinations thereof.

According to a preferred embodiment of the invention, said apparatus comprises at least one collecting surface and an inlet chamber connected to said, at least one inlet, said inlet chamber is provided with a plate with through-going apertures or one or more flow directing tubes, through which said fluid passes and being evenly distributed over at least a part of the cross-sectional area of the apparatus, and optionally guiding means for guiding the flow of fluid towards said collecting surfaces.

Said vessel has a generally circular cross-section and comprises a vertical, generally cylindrical sidewall, a vessel top and a vessel bottom, said vessel top, a gas/liquid interface or combinations thereof, constitutes the collecting surface, said vessel top comprises a particle trap comprising a cylindrical cap in which said outlet is provided.

According to a preferred embodiment of the apparatus, said collecting surface comprises at least one internal cap with a generally vertical, cylindrical section with a top enclosure and a smaller, cylindrical cap at the top centre of the top enclosure, said outlet comprises a generally cylindrical part which projects into the vessel and into which cylindrical part the cylindrical cap projects, that an outlet tube for separated lighter particles is connected to the cylindrical cap and projects out through the cylindrical part, that the upper part of the vessel, above the top enclosure comprises a chamber with a particle outlet tube and optionally with an outlet vortex breaker.

According to another preferred embodiment, the apparatus comprises several internal caps placed vertically above each other, and that each cap is provided with a separate particle outlet tube, and the apparatus further comprises several circular vanes mounted inside the vessel's cylindrical part, between each cap, said circular vanes has a large circular opening in the centre.

According to another preferred embodiment, the apparatus comprises a substantially horizontal, elongated, mainly cylindrical vessel with one or more collecting surfaces, where the main collecting surface is the gas/liquid interface, the internal upper part of the vessel and additionally either one or more substantially horizontal superimposed plates or at least one, preferable more substantially horizontal concentric pipes.

Said inlet device preferably comprises an inlet manifold with several apertures for distributing the fluid to be separated into the vessel, said inlet manifold is constituted of a tube which runs substantially parallel with the horizontal axis of the vessel.

The cylindrical vessel preferably has an inlet for fluid to be separated at one end and an outlet for separated fluid at the other end, that the inlet device comprises an expansion cone and an inlet vane adjacent the inlet to distribute the fluid to be treated, that the collecting surfaces consist of the gas/liquid interface and/or the inside upper half of the vessel and at least two concentric tubes with angular vanes in order to provide the fluid with a rotational movement, and that the vessel has an outlet for the removal of light particles and an outlet for the removal of heavier particles.

The longitudinal axis of the cylindrical vessel is preferably angular in relation to the horizontal axis, resulting in that the level of the outlet is higher than the level of the inlet.

According to a preferred embodiment of the apparatus according to the invention, the collecting surfaces are a combination of several solid surfaces and one or more gas/liquid interfaces, said solid surfaces are annular and that some of the annular solid surfaces are superimposed with a mutual vertical spacing and have an outer diameter which is less than the inner diameter of the vessel, where the cross-section of the collecting surfaces has a truncated cone form or an inverted V-form.

Embodiments of the inventive method and apparatus will be explained more detailed below, with reference to the accompanying drawings.

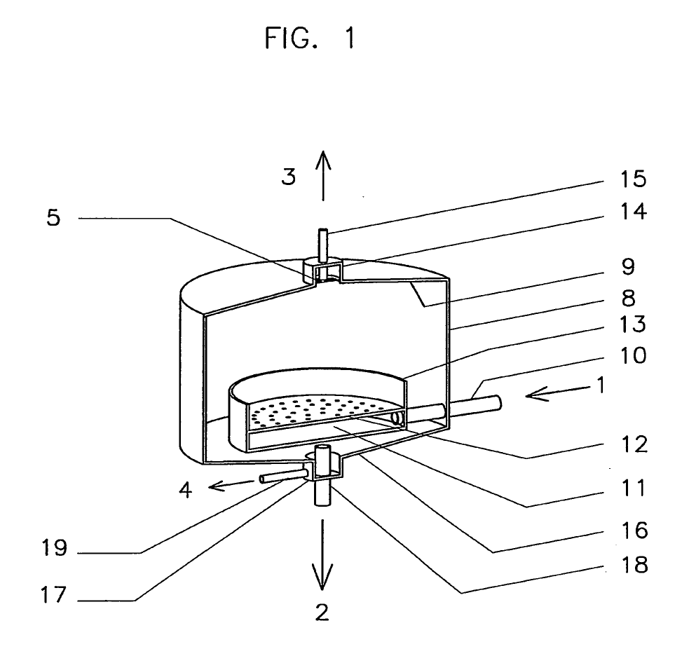

FIG. 1 shows a first embodiment of the invention as a basic vertical vessel design, top vessel enclosure as the light particle collecting surface;

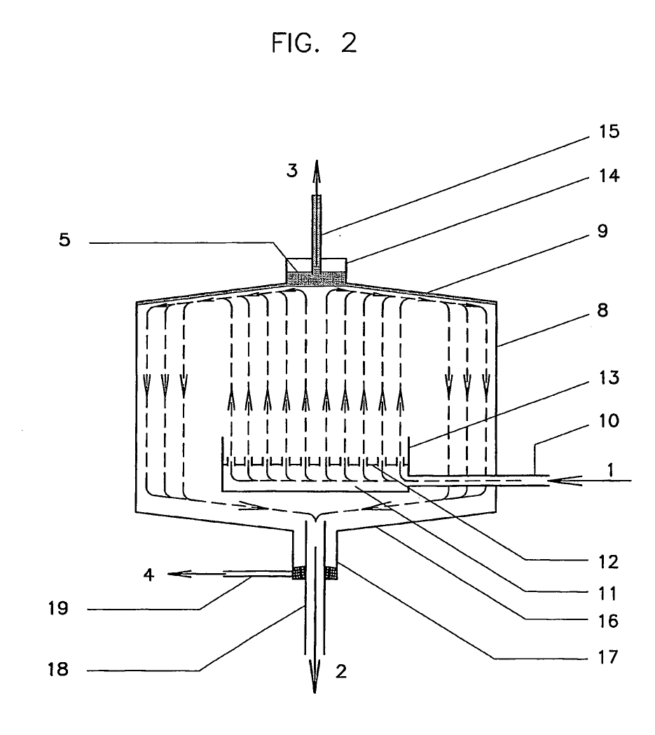

FIG. 2 shows the schematic flow pattern for a vertical vessel design according to a first embodiment of the invention; shown in FIG. 1

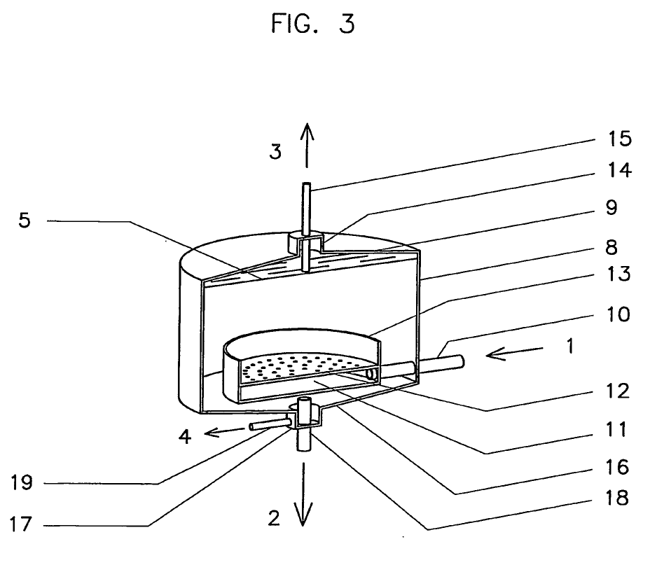

FIG. 3 shows a variant of the first embodiment according to the invention, utilizing the liquid/gas interface as the light particle collecting surface;

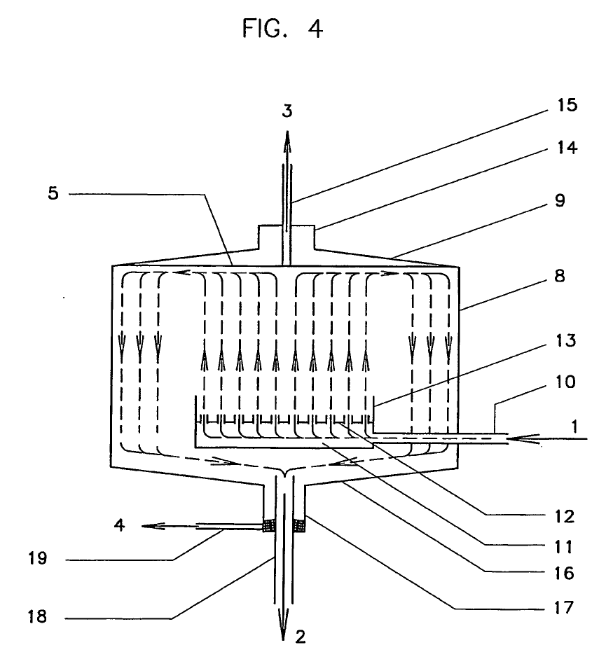

FIG. 4 shows the schematic flow pattern for a vertical vessel design according to a first embodiment of the invention; shown in FIG. 3

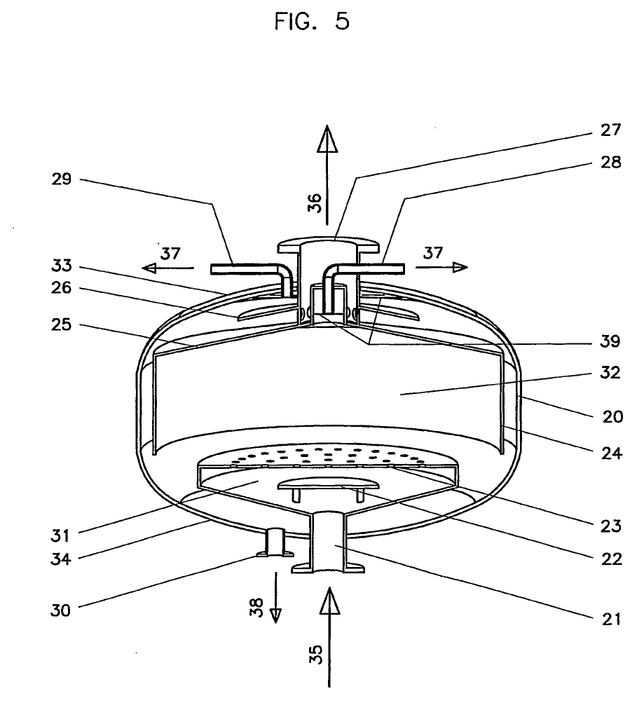

FIG. 5 shows a two stage vertical vessel design according to second embodiment of the invention, utilizing top enclosures as collecting surfaces;

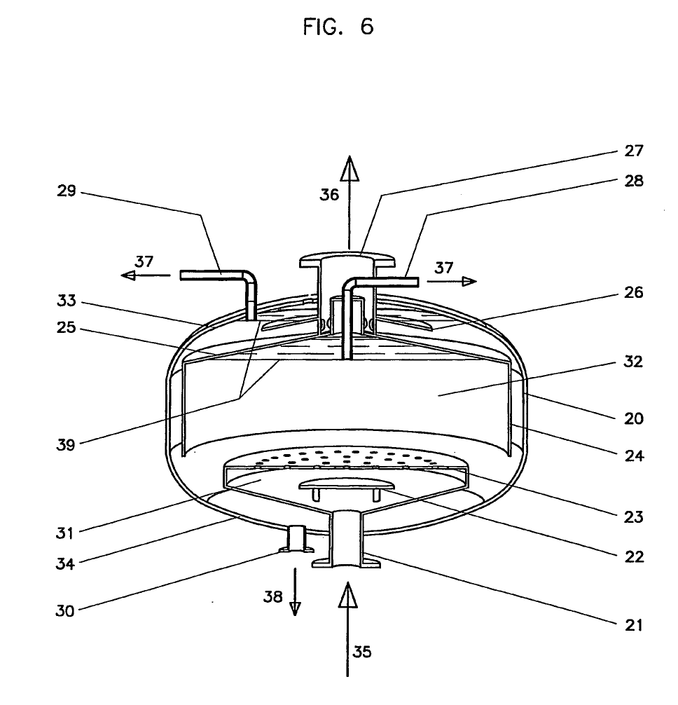

FIG. 6 shows a variant of the two stage vertical vessel design according to second embodiment of the invention, utilizing the liquid/gas interfaces as the collecting surfaces;

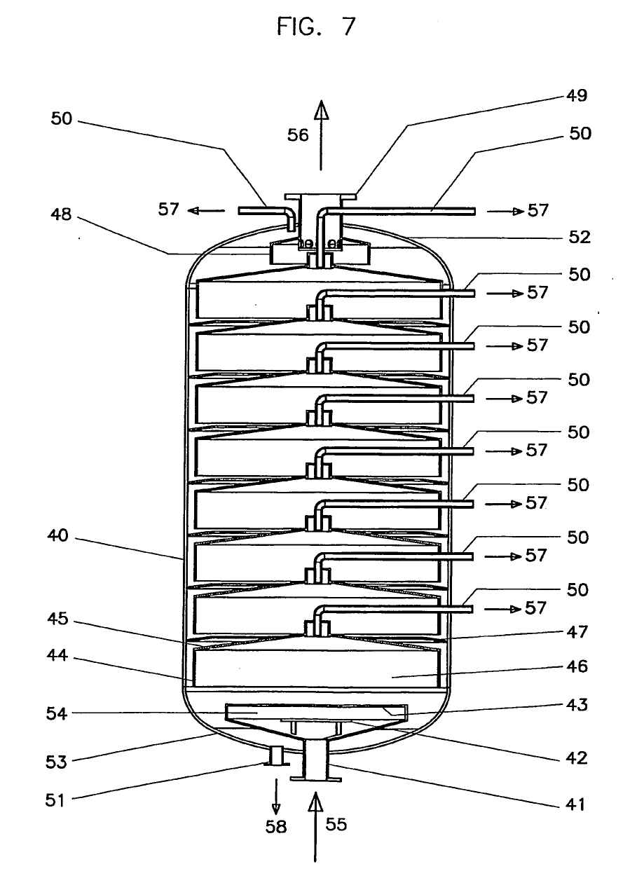

FIG. 7 shows a multistage vertical vessel design according to a third embodiment of the invention;

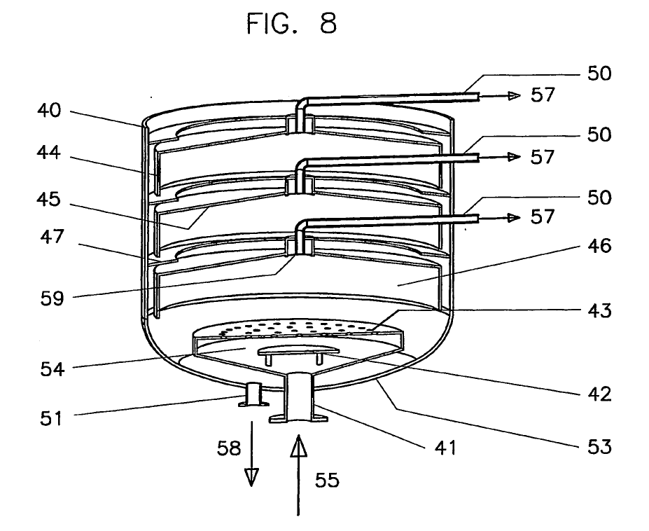

FIG. 8 shows a detail of the multistage vertical vessel design according to the third embodiment of the invention shown in FIG. 7, utilizing top enclosure of the chambers as collecting surfaces;

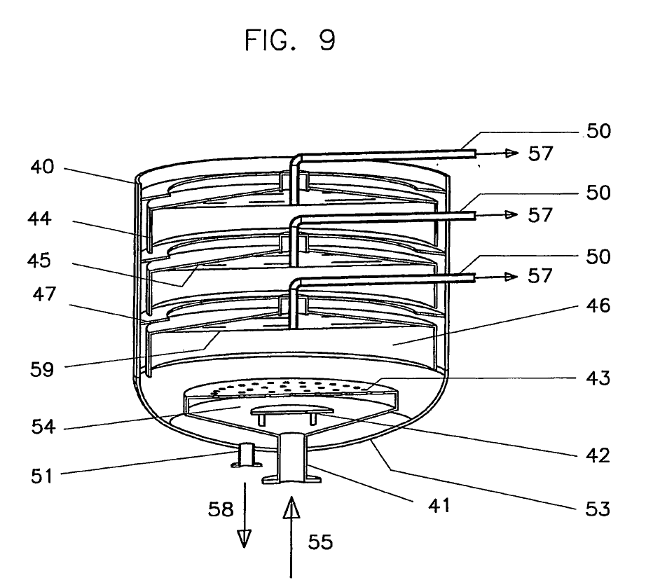

FIG. 9 shows a detail of the multistage vertical vessel design according to the third embodiment of the invention shown in FIG. 7, utilizing the liquid/gas interface of the chambers as the light particle collecting surfaces;

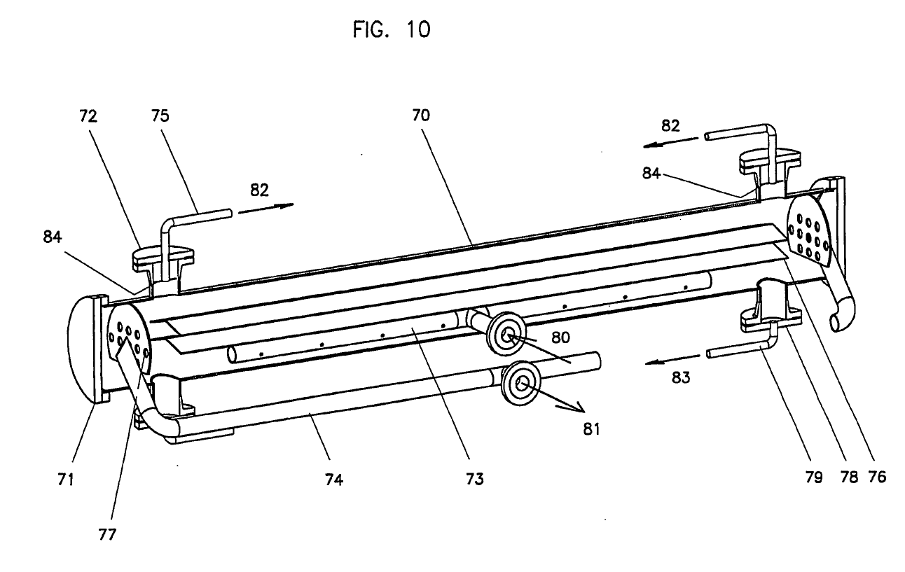

FIG. 10 shows a horizontal vessel design according to a fourth embodiment of the invention, utilizing fixed surfaces for light particle collection;

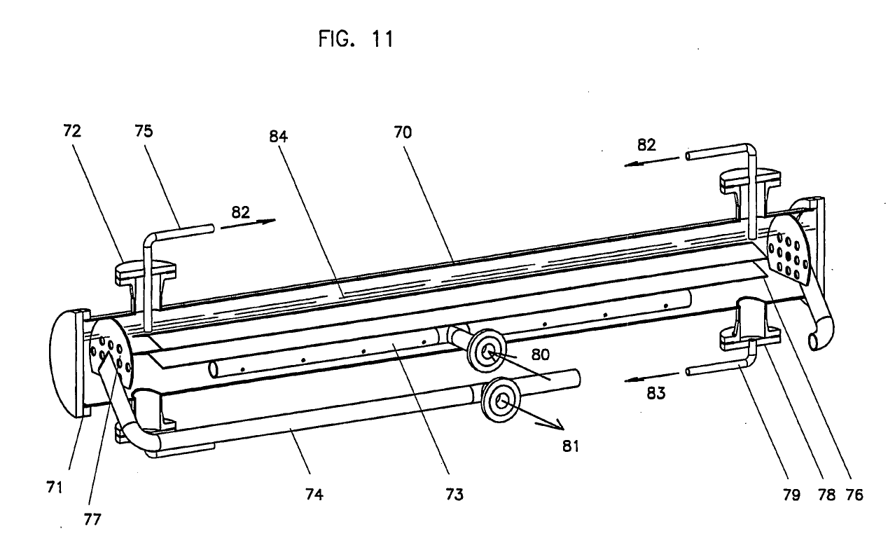

FIG. 11 shows a horizontal vessel design according to a fourth embodiment of the invention, utilizing a combination of fixed surfaces and liquid/gas interface as light particle collecting surfaces;

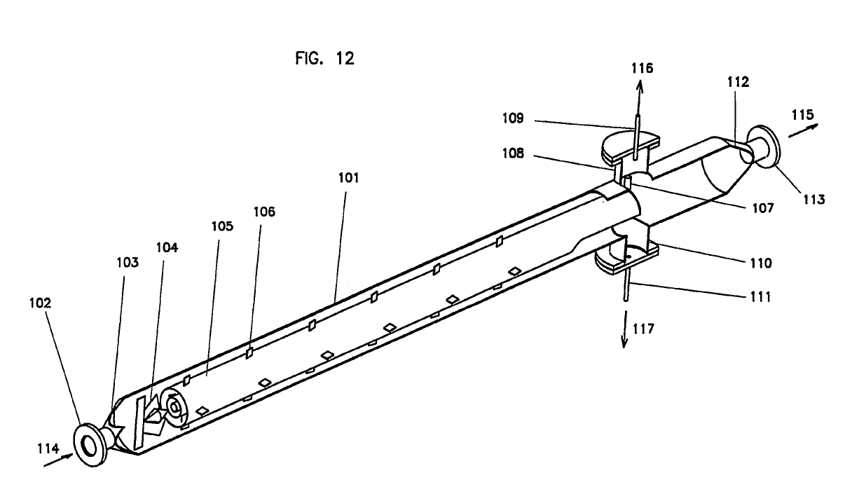

FIG. 12 shows a horizontal pipe design according to a fifth embodiment of the invention;

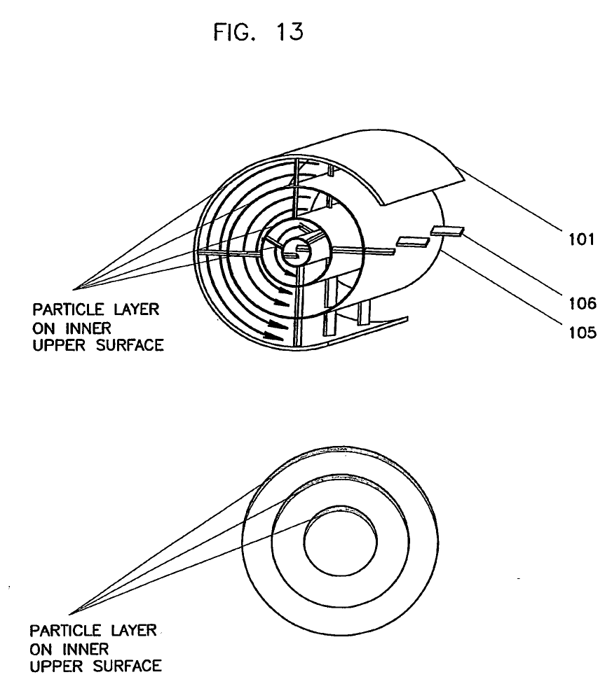

FIG. 13 shows a schematic flow pattern for the horizontal pipe design according to the fifth embodiment of the invention as shown in FIG. 12;

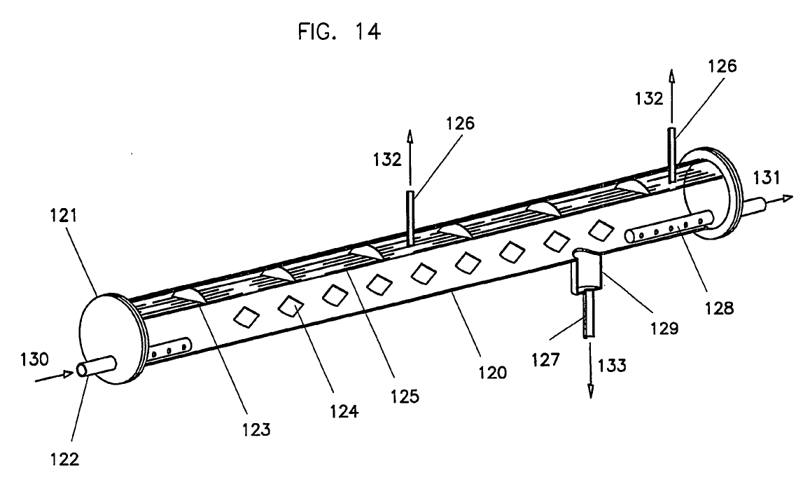

FIG. 14 shows a variant of the fifth embodiment of the invention utilizing liquid/gas interfaces as collecting surfaces in a horizontal pipe design;

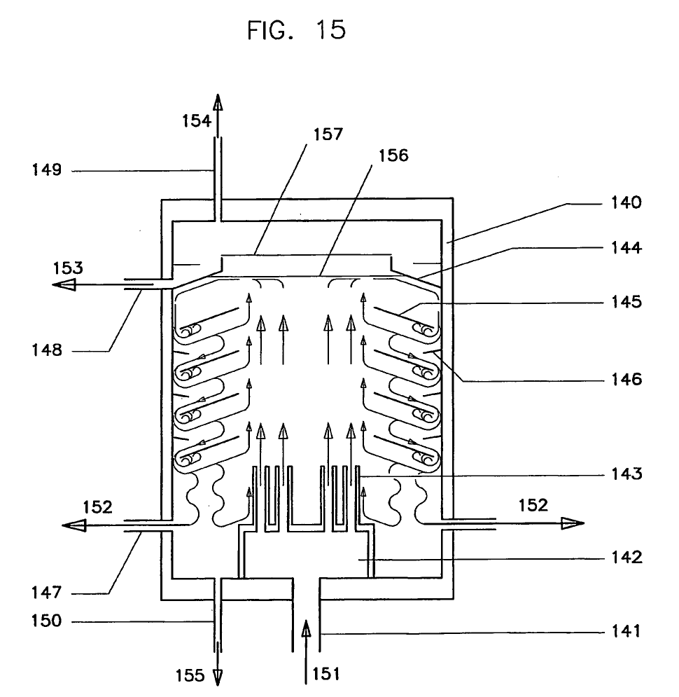

FIG. 15 shows a vertical vessel design according to the sixth embodiment of the invention using multiple fixed plates in combination with gas/liquid interface as the light particles collection surfaces;

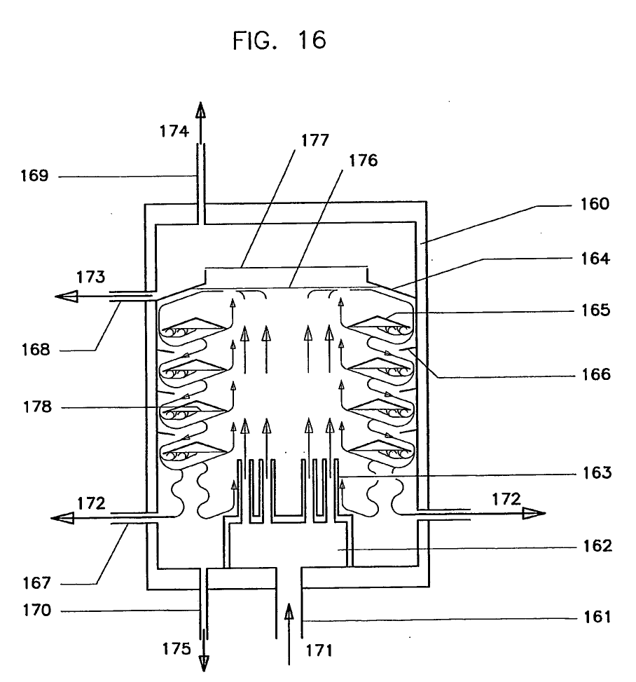

FIG. 16 shows a vertical vessel design according to the sixth embodiment of the invention using multiple gas/liquid interfaces as the light particles collection surfaces;

FIGS. 1 through 16 show typical embodiments of the present invention.

FIG. 1 shows a basic vertical vessel design of first embodiment of the apparatus according to the invention and comprises a vertical, cylindrical vessel 8 enclosed by a top cone 9 and a bottom cone 16. Fluid inlet pipe 10 enters into an inlet chamber 11. The inlet chamber has a top device 12 with apertures to give the fluid an upward directed flow into the main chamber of the vessel. A vertical cylindrical guide 13 is provided to further help direct the flow upwards. The top enclosure consists of a cylindrical cap 14 at the centre. A particle outlet pipe 15 is suspended from the centre of the cap 14. The bottom cone 16 is equipped with a cup 17 at the centre. Through the bottom of the cup is the outlet pipe 18. An outlet pipe 19 for heavy particles extends radially from the cups cylindrical section.

FIG. 2 shows a schematic of the flow pattern for the first embodiment of the invention. The upper vessel enclosure 9 is utilized as the light particle collecting surface.

FIG. 3 shows a variant of the first embodiment of the invention, utilizing the liquid/gas interface 5 as the collecting surface for light particles. The particle outlet pipe 15 is lowered into the vessel to maintain a gas pocket.

FIG. 4 shows a schematic of the flow pattern of first embodiment of the invention as shown in FIG. 3, utilizing the gas/liquid interface as the collecting surface for light particles.

FIG. 5 shows a second embodiment of the apparatus according to present invention and comprises a two stage vertical vessel design of the invention. A vertical, cylindrical vessel 20 closed at the bottom and top by end caps 33 and 34. Fluid inlet pipe 21 in the centre of the bottom end cap enters into a flow inlet chamber 31. The chamber is equipped with a flat circular plate 22 to redirect and spread the flow. The top of the chamber consists of a device 23 with apertures for the fluid. An internal chamber 32 consists of a vertical cylindrical section 24 with a cone shaped top enclosure 25 including a smaller cylindrical cap at the top, centre of the top enclosure 25. From the small cap there is a particle outlet pipe 28 suspended. The upper part of the vessel comprises a chamber with an outlet vortex breaker 26, an outlet pipe 27 and a particle outlet pipe 29. At the bottom of the vessel there is an outlet pipe 30 for heavy particles. The pipe 30 is vertical and positioned close to the vessel's bottom centre. The embodiment shown here is utilizing the upper enclosures 25 and 33 as collecting surfaces for the light particles. The liquid/gas interface is set at the very top of the chambers.

FIG. 6 shows a variation of the same second embodiment of the invention as FIG. 5 with the collection of light particles taking place at the liquid/gas interfaces 39. The bottom of the particle discharge pipes 28 and 29 are lowered into the chambers to create a gas pocket.

FIGS. 7, 8 and 9 illustrate a multiple stage vertical vessel design according a third embodiment of the present invention. Vessel 40 consists of a vertical cylindrical section closed off by an end cap 52 in the upper end and an end cap 53 in the lower end. Inlet pipe 41 enters vessel through the bottom end cap and leads to a circular inlet chamber 54. Inside the chamber is a flow breaker plate 42. Upper enclosure of chamber 54 is a circular device 43 with apertures for distributing flow across a large cross section of the vessel. Internal collection chamber 46 consists of cylindrical section 44 and a top enclosure 45. The diameter of the cylinder 44 is such that an annulus is formed between the inside wall of the vessel's cylindrical part 40 and the outside of the cylindrical cap 44. Through the top enclosure is the end of a small pipe 50 suspended, the other end exiting to the outside of the vessel. Above the collection chamber 46 is a circular vane 47 mounted to the inside of the vessel's cylindrical part. The vane has a large circular opening in the centre. Next there are multiple sets of internal chambers 46 consisting of the same elements: 44, 45, 47 and 50. The top chamber of the vessel has an outlet flow vortex breaker 48 and an outlet pipe 49. The particle outlet pipes 50 exit through the main flow outlet and a second particle outlet pipe 50 exits through the vessel's top end cap. Outlet pipe 51 for discharge of heavy particles is located at the bottom of the vessel.

FIG. 8 shows details of the third embodiment of the invention, utilizing the chambers' top enclosure 45 as the collecting surface for light particles. The position of the bottom end of the particle outlet pipe 50 sets the level of the liquid/gas interface for each chamber.

FIG. 9 shows the details of a variant of the third embodiment of the invention utilizing a liquid/gas interface as the collecting surface for light particles. The bottom end of the particle outlet pipe 50 is lowered into the chambers 46 to create a larger gas pocket to increase the liquid/gas interface as a particle collecting area.

FIG. 10 shows a fourth embodiment of present invention where the apparatus is incorporated in a horizontal vessel 70 with end caps or blind flanges 71. Two or more nozzles 72 are placed on top of the vessel, vertical and perpendicular to the vessel's horizontal axis. Nozzles are each equipped with outlet pipes 75. Inlet manifold 73 and outlet pipes 74 run parallel to the vessel's horizontal axis. Horizontal collection plates 76 are located at the centre of vessel. Perforated plates 77 are placed next to opening of outlet pipe 74 at each end of vessel. Two ore more nozzles 78 are placed underneath the vessel, vertical and perpendicular to the vessel's horizontal axis. Nozzles are each equipped with outlet pipes 79.

FIG. 11 shows the same fourth embodiment as FIG. 10 of the present invention. The bottom end of particle outlet pipes 75 are lowered into the main vessel body to lower the liquid/gas interface to be used as a collecting surface for light particles.

Figure no. 12 shows a fifth embodiment of the apparatus according to the invention where the apparatus is incorporated in a horizontal pipe 101. Inlet end has a flange 102 attached to an expansion cone 103. The guiding vanes 104 are placed in the entry area of the pipe 101. Further there is a set of concentric pipes 105, with vanes 106. At the end of the concentric pipes is a collector plate and pipe assembly 107 positioned vertically in the pipe 101. Further a nozzle 108 is positioned at the upper half of the pipe 101. The nozzle is equipped with a discharge pipe 109 through the flange. At the bottom of the pipe 101 there is a nozzle 110 for heavy particles. This well is equipped with a discharge pipe 111 through the bottom flange. A reducer cone 112 is connected to the outlet flange 113 at the end of the pipe.

FIG. 13 shows details of flow patterns and particle collecting surfaces for the fifth embodiment of the invention as shown in FIG. 12.

FIG. 14 shows a variation of the fifth embodiment of the invention. A horizontal pipe vessel 120 is closed off by flanges 121 in both ends. Inlet pipe 122 goes through one flange at one end and outlet pipe 128 goes through the flange at the opposite end. Two or more outlet pipes 126 are positioned at the top of the vessel, vertical and perpendicular to the vessel's horizontal axis. 6 or more dividers 123 are placed vertically and across the top inner section of the vessel. A number of vanes 124 are placed along the inside bottom half of the vessel, each set at an angle to the horizontal axis of the vessel. A heavy particle collection well 129 with an outlet pipe 127 is positioned underneath the vessel, close to the main fluid outlet pipe 128.

FIG. 15 shows a sixth embodiment of the present invention comprising a vertical, cylindrical vessel 140, inlet pipe 141, inlet chamber 142, chamber outlet apertures 143, particle collecting trough 144, 4 or more collecting plate 145, 4 or more diverter plates 146, one or more main fluid outlet pipes 147, light particles outlet pipe 148, gas outlet pipe 149 and heavy particles outlet pipe 150.

FIG. 16 shows a variant of the same sixth embodiment of the present invention, equipped with a different collecting plate 165. The embodiment comprising a vertical, cylindrical vessel 160, inlet pipe 161, inlet chamber 162, chamber outlet apertures 163, particle collecting trough 164, 4 or more v-shaped collecting plates 165, 4 or more diverter plates 166, one or more main fluid outlet pipes 167, light particles outlet pipe 168, gas outlet pipe 169 and heavy particles outlet pipe 170.

The operation of the apparatus according to present invention will be explained below, with reference to the embodiments described over and shown in the accompanying drawings.

The invention relates to the separation and extraction of submerged particles from a fluid. The particles separated can have the consistency of solids, fluids or gases. The process and apparatus are designed to operate as a continuous process.

The invention is applicable in all processes where submerged particles are to be extracted from a fluid. Examples of applications are:

Oil particles from water (crude oil or refined oil products)

Gas from water

Solids (flock) from water

Food processing industry

Paper/pulp industry

The invention is applicable within all industries dealing with separation of submerged substances having differences in density.

Theory of Operating Principle for Separation of Submerged Particles from a Fluid

The theory of separation of submerged particles from a fluid for the present invention is here described using the example of separation of submerged oil particles from water. Small amounts of hydrocarbons or oil particles are submerged and evenly distributed in water. The density of the oil particles is lower than that of the water, but due to their small size they will stay submerged in the water as long as the fluid is in motion in a pipe or vessel. The present invention will move the light particles with the flow to a collecting surface. The collecting surface can be either:
i)—a fixed surface such as the inside of a vessel or a collector plate
ii)—a free surface such as a liquid/gas interface
iii)—a fixed and a free surface used in combination.

### Particle Separation in a Vertical Vessel

i) With reference to FIGS. 1 and 2 the theory of the present invention with regards to separation of particles from a fluid utilizing a fixed collecting surface in a vertical vessel can be described as follows:

Incoming untreated water containing oil particles enters the vessel and is guided upwards towards the upper inner surface 9, or ceiling surface, of the vessel. Having a bulk fluid velocity below a critical value the water will flow into the ceiling surface and be deflected outwards in a radial direction. During this deflection oil particles will come in contact with the vessel ceiling surface and adhere to this surface due to buoyancy and resulting friction forces. This can be described as an inverted settling process, using buoyancy as opposed to gravity. As more particles are brought in they will coalesce and build up an oil film or layer at the upper inside surface.

Particles in the growing oil layer will move towards the centre and be discharged through the particle outlet pipe 15. The main fluid, or water, will flow downwards along the vessel outer wall ant exit through the bottom outlet pipe 18.

ii) With reference to FIGS. 3 and 4 the theory of the present invention with regards to separation of particles from a fluid utilizing a liquid/gas interface as the collecting surface, referred to as a free surface can be described as follows:

Incoming untreated water containing oil particles enters the vessel and is guided upwards towards the surface 5, or free surface made up of the liquid/gas interface. Having a bulk fluid velocity below a critical value the water will flow into the surface and be deflected outwards in a radial direction. During this deflection oil particles reaching the surface will stay afloat as long as the surface remains calm. As more particles are brought in they will coalesce and build up an oil film or layer on the surface. The particles can be siphoned off by the suspended particle discharge pipe 15.

iii) With reference to FIG. 15 the theory of the present invention with regards to separation of particles from a fluid utilizing a combination of fixed plates and liquid/gas interface as the collecting surfaces can be described as follows:

Incoming untreated water containing oil particles enters the vessel and is guided upwards towards the surface 156, referred to as a free surface made up of the liquid/gas interface. Having a bulk fluid velocity below a critical value the water will flow into the surface area and be deflected outwards in a radial direction. During this deflection the oil particles reaching the surface with the flow will stay afloat as long as the surface remains calm. This is referred to as a primary separation. Water will flow downwards underneath the trough 144, through the annulus between the vessel wall 140 and collecting plate 145, creating an eddy underneath the cone. This eddy or random flow causes particles to come in contact with the plate surface and coalesce underneath said plate. The diverter plate 146 assures that fluid will not go straight down along the vessel wall, but be directed back into the vessel's centre area. As particles coalesce larger oil droplets will be released from the collector plate's inner edge and float to the top surface. Light particles, or oil, are removed by raising the liquid level to skim into the trough 144 and discharge through outlet pipe 148.

### Particle Separation in a Horizontal Vessel or Pipe

i) Testing of horizontal pipe flow has shown that given the right flow velocities the oil particles which come in contact with the pipe's upper inside surface, or ceiling surface, will stick to this surface. This can be described as an inverted gravity settling process.

As more particles are brought into contact with the pipe ceiling surface the oil particles will coalesce and form a layer of oil. By stirring or rotating the flow all oil particles will eventually be attached to this surface layer and the water will contain very few or no oil particles at all.

Two conditions need to be present to achieve separation as described:
1. Flow velocity has to be below a certain critical value. This critical value will vary depending on the relative difference in density between the submerged particles and the fluid. If the velocity is too high the drag forces acting upon the particle will be larger than the friction forces holding it in place and the particle will follow the fluid.
2. Careful mixing or stirring of the fluid has to take place to allow all submerged oil particles to eventually come in contact with the ceiling surface of the pipe.
   Turbulent and critical pipe flow will not meet condition number 1.
   Laminar pipe flow will not meet condition number 2.

To achieve the desired effect of separating submerged oil particles from water the pipe flow velocity has to be kept below a critical value and the fluid has to be given a rotating or rolling motion inside the pipe by use of fixed vanes or wings. The rotating or rolling motion will assure that all submerged particles distributed in the fluid will, at one point or other, come in contact with and stick to the ceiling surface of the pipe.

The effectiveness of the process can be seen as a function of how many submerged particles can be brought into contact with a ceiling surface per unit of time.

To further increase the effectiveness of separation taking place per unit length of pipe the ceiling surface area can be increased by use of several concentric pipes.

The pipe separation process described above can be referred to as a fixed surface separation process.

FIG. 14 shows an embodiment of the present invention utilizing both fixed and free surfaces for achieving effective separation. In this embodiment the upper half of the inside surface of the pipe functions as a collecting surface, partly a fixed surface and partly a liquid/gas interface at the very top. The liquid/gas interface is designed by use of internal divider plates 123, creating gas pockets. Vanes 124 placed at an angle will force the fluid to rotate and mix as it flows through the pipe. Particle will be exposed to the surfaces, separate from the bulk fluid and coalesce before being removed through pipes 126. The process is repetitive and the amount of particle removal a function of the length of the pipe.

The operation of the embodiments of the separation apparatus according to the invention will now be described with reference to FIGS. 1-16.

FIG. 1 shows a first embodiment of the separation apparatus according to the present invention, utilizing a fixed surface as the collection surface. At steady operational state the liquid/gas interface level is at the lower end of particle outlet pipe 15. Untreated fluid 1 with submerged particles is entering the vessel through inlet pipe 10, flowing into the inlet chamber 11. Said chambers upper enclosure 12 is equipped with apertures to generate a slow flow in the vertical, upwards direction in the centre of the vessel, towards the nearly horizontal surface of the vessel's top enclosure 9. At a low velocity the fluid is then in contact with and deflected by the top enclosure 9, then flowing in a radial, near horizontal direction towards the vessels outer walls 8 where it is again deflected to take on a downward flow pattern before exiting as treated fluid 2 through the bottom main outlet 18. This flow pattern with a large cross sectional area towards a large, nearly horizontal surface will ensure that a large number of particles will be brought in contact with the fixed surface at a velocity low enough for the particles to adhere. Particles will coalesce and build a layer of particles underneath the conical top enclosure 9 of the vessel. These particles 3 will eventually gravitate towards the centre cap 14 to be discharged through the particle outlet pipe 15. Heavy particles 4 will follow the fluid and settle at the bottom enclosure 16 of the vessel to be discharged as heavy particles through cup 17 and pipe 19.

FIG. 2 shows the flow pattern of this first embodiment of the invention.

FIG. 3 shows a variant of the first embodiment of the separation apparatus according to the invention, utilizing a free surface 5 as the collection surface. At steady operational state the fluid surface level is at the lower end of particle outlet pipe 15 at the liquid/gas interface. Untreated fluid 1 with submerged particles is entering the vessel through inlet pipe 10, flowing into the inlet chamber 11. Said chambers upper enclosure 12 is equipped with apertures to distribute the fluid over a large cross sectional area generating a slow flow in the vertical, upwards direction in the centre of the vessel, towards the liquid/gas interface creating the horizontal collecting surface 5. At a low velocity the particles in the fluid are brought to the surface and stay afloat as the bulk fluid is deflected to flow in a radial, horizontal direction towards the vessels outer walls 8 where it is again deflected to take on a downward flow pattern before exiting as treated fluid 2 through the bottom main outlet 18. This flow pattern with a large cross sectional area moving towards a large horizontal surface will ensure that a large number of particles will be brought in contact with the free surface at a velocity low enough for the particles to stay afloat. Particles will coalesce and build a layer of particles on the surface 5. These particles 3 will be siphoned off and be discharged through the particle outlet pipe 15. Heavy particles 4 will follow the fluid and settle at the bottom enclosure 16 of the vessel to be discharged through cup 17 and pipe 19.

FIG. 4 shows the flow pattern of the variant in FIG. 4 of the first embodiment of the invention.

The second embodiment of the invention shown in FIG. 5 comprises the same principle as described for the first embodiment, but this second embodiment shows the invention working in two stages. The apparatus contains two chambers for separation: the inner chamber 32 and the vessel itself 20. At a steady operational state both chambers are filled completely up to the lower end of particle discharge pipes 28 and 29. Fluid 35 with submerged particles enters the inlet chamber 31 through inlet pipe 21. The incoming flow will hit the plate 22 to break the concentrated and relatively high velocity flow entering the chamber. Through apertures in the upper enclosure 23 of said inlet chamber the flow will acquire a uniform, vertical, upwards moving flow pattern. As the fluid comes in contact with the inside of the upper, near horizontal, top enclosure 25 of the chamber the lighter particles will adhere to the surface and coalesce. Eventually the layer of coalesced particles will move towards the centre of the enclosure to be discharged through the particle outlet pipe 28. Heavy particles will follow the fluid downwards along the cylindrical part 24 of the inner chamber and then drop to the bottom of the vessel to be discharged through heavy particles 38 outlet 30.

The fluid will enter into the upper chamber in the vessel and a new process of particles adhering to the inside of the top enclosure 33 will take place. A vortex breaker 26 is in place to secure an even flow pattern through the openings into the outlet pipe 27. Particles 37 are discharged through outlet pipe 29.

A variant of the second embodiment of the invention is shown in FIG. 6. For this variant of the second embodiment the invention is working in two stages with a liquid/gas interface as the collecting surface. The apparatus contains two chambers for separation: the inner chamber 32 and the vessel itself 20. At a steady operational state both chambers are filled up to the lower end of particle discharge pipes 28 and 29. These pipes are now suspended further down into their chambers to allow for a larger gas pocket to form at the top of the chambers. Fluid 35 with submerged particles enters the inlet chamber 31 through inlet pipe 21. The incoming flow will hit the plate 22 to break the concentrated and relatively high velocity flow entering the chamber. Through apertures in the upper enclosure 23 of said inlet chamber 31 the flow will acquire a uniform, vertical, upwards moving flow pattern. As the fluid flows to the free surface 39 of the lower chamber 32 it will release lighter particles that will float on said surface. Light particles 37 will be siphoned off through outlet pipe 28. Heavy particles will follow the fluid downwards along the cylindrical part 24 of the inner chamber and then drop to the bottom of the vessel to be discharged through heavy particles 38 outlet 30.

The fluid will enter into the upper chamber in the vessel and a new process of particles being released at the free surface 39 will take place. A vortex breaker 26 is in place to secure an even flow pattern of treated fluid 36 exiting through the openings into the outlet pipe 27. Particles 37 are discharged through outlet pipe 29.

The third embodiment of the present invention shown in FIG. 7 has a multiple stage design based on the same principle as the design shown in FIG. 1. The apparatus contains 9 stages for separation: 8 inner chambers and the top of the vessel 40. At a steady operational state all chambers are filled completely up to the lower end of particle discharge pipes 50.

Fluid 55 with submerged particles enters the vessel 40 through the inlet pipe 41. Plate 42 in the inlet chamber will break the flow and reduce the fluid velocity. The inlet chamber's 55 upper enclosure 43 distributes fluid through apertures to achieve a controlled low velocity flow upwards in the centre of the first chamber.

As the fluid comes in contact with the inside of the upper, near horizontal, top surface 45 of the chamber 46 the lighter particles will adhere to this ceiling surface and coalesce. Eventually the layer of coalesced particles will move towards the top center to be discharged through the particle outlet pipe 50. Heavy particles will follow the fluid downwards along the cylindrical part 44 of the inner chamber 46 and then drop to the bottom of the vessel to be discharged through heavy particles 58 outlet pipe 51.

Further, the fluid will enter into the next chamber in the vessel through the annulus opening between the inside of the cylindrical vessel wall and the outside of the chamber wall 44. A diverter plate 47 will guide the fluid towards the center top enclosure of the next chamber. A new process of particles adhering to the inside of the top enclosure 45 of this chamber 46 will take place. The process will be repeated for the next chambers including the top enclosure 52 of the vessel 40. A vortex breaker 48 is in place to secure an even flow pattern for the treated fluid 56 through the openings into the outlet pipe 49. Particles 57 are discharged through particle outlet pipes 50.

FIG. 8 shows details of the third embodiment of the invention, with the chambers completely filled with fluid up to the lower end of particle outlet pipe 50, using fixed surfaces for collection of particles.

FIG. 9 shows a variation of the third embodiment of the present invention. The end of the light particle outlet pipes 50 are lowered into the chambers, creating a liquid/gas interface 59 as the particle collection surface.

The fourth embodiment of the invention shown in FIG. 10 consists of a horizontal vessel 70 with rotating or angular internal fluid flow in a fully filled vessel. Vessel 70 is capped by blind flanges 71 at each end. Untreated fluid 80 enters vessel 70 as small jets evenly distributed through inlet manifold 73. The angle and velocity of the jets determine the spin or angular velocity of the fluid in the vessel. Lighter particles will come in contact with and adhere to the upper half of the vessels inside surface based on the principles discussed above. Additional surface area for collection of light particles is provided by the collector plates or half-pipes 76. Rotating fluid will move towards the two ends of the vessel and discharge through vortex breaker plates 77 before entering outlet pipes 74 as treated fluid 81. The liquid/gas interface 84 is located inside the collection wells 72.

Collected light particles will coalesce and eventually flow into the particle collection wells 72. Light particles 82 will be discharged through outlet pipes 75. Heavy particles 83 will gravitate to the bottom and be collected in collection wells 78 and be discharged through outlet pipes 79.

FIG. 11 shows a variant of the fourth embodiment of the invention. Light particle outlet pipes 75 have been lowered into the vessel to create a gas pocket in the upper part of the vessel. For this variant of the fourth embodiment of the invention there will be a liquid/gas interface working as the collection surface for light particles. Collector plates 76 can also be fitted with gas pockets to increase liquid/gas interface surface area.

FIG. 12 shows a fifth embodiment of the present invention as a horizontal pipe design. Untreated fluid 114 enters the pipe through the inlet flange 102 and expansion cone 103. Guide vane 104 gives the fluid an initial spin or rotation before it enters into a set of concentric pipes 105. The pipes are equipped with several sets of guides or wings 106 to ensure a continued rotation of the fluid throughout the pipe section 105. Lighter particles will settle and adhere to the inside upper surface of the pipes 105 as well as to the inside of the main pipe 101 as the fluid moves through the pipe. The velocity of the fluid has to be below a critical value for the particles to adhere to the collecting surfaces. This critical value will vary with the difference in density between the bulk fluid and the lighter particles to be separated. At the downstream end of the pipes 105 there is an end cap and a collection pipe 107 to bring the collected lighter particles 116 into the collection well 108 before being discharged through outlet pipe 109. Heavy particles will gravitate to the bottom and flow towards the bottom collection well 110. Discharge of heavy particles 117 through outlet pipe 111. Treated fluid 115 will exit through reducer cone 112 and flange 113.

FIG. 13 shows details of the pipe internals and collection surfaces of the fifth embodiment of the present invention.

FIG. 14 shows a variant of the fifth embodiment of the present invention. Untreated fluid 130 enters the vessel through inlet pipe 122. The fluid enters through openings on the side of pipe 122 to create a spin inside the vessel. The end of pipe 122 is capped off.

The fluid will continue to spin and be guided through the vessel by a number of vanes 124. The vanes will assure continuous rotation and random movement of the fluid to continuously bring new particles to the collecting surfaces.

Divider plates 123 are positioned at the upper surface inside of the vessel to create gas pockets for a liquid/gas interface to be used as a surface 125 for separation and collection of lighter particles. As more particles accumulate they will move along the pipe and be discharged through outlet pipes 126 as light particles 132. Heavier particles 133 will be trapped in well 129 and discharged through outlet pipe 127. Treated fluid 131 outlet pipe 128 is designed with several openings to assure that no vortex will build up and disturb particle collecting surface at outlet.

FIG. 15 shows a sixth embodiment of the present invention working as a four phase separator the apparatus consists of a vertical cylindrical vessel where incoming untreated fluid 151 enters through pipe 141 into an inlet chamber 142. Apertures 143 distribute the flow over a large portion of the vessels horizontal cross sectional area. The fluid moves towards a liquid/gas interface 157. Said interface works as a free surface for collection of lighter particles. As light particles are brought to the surface with the flow of the fluid said particles will remain floating as the bulk fluid will deflect in a radial flow pattern and be diverted downwards underneath trough 144. As the fluid flows through the annulus between the vessel 140 and the conical collecting plate 145 said fluid will create an eddy underneath the cone. The eddy has a random flow pattern and will move particles towards the surface where they will adhere and further coalesce to form a layer of particles as is described in the theory of the separation process. The layer of particles will move towards the centre opening of the cone and be released to float to the free surface 156. Diverter plates 146 along the inside wall of the vessel ensure that all the fluid is deflected towards the centre of the vessel and not be allowed to go straight down along the wall to the outlet pipe 147.

A portion of the fluid will be pulled towards the centre to mix with the vertical upwards flow and reach the top free surface. The remaining fluid will turn downwards to flow past the next collecting cone, repeating the separation process. The treatment process will separate new particles from the fluid for each step as the fluid moves down towards the outlet pipe 147. Treated fluid 152 will exit through one or more discharge pipes 147.

Heavier particles 155 will fall to the bottom of the vessel to be discharged through outlet pipe 150. Gas 154 will be released through outlet pipe 149. Lighter particles accumulating at the free surface 156 will be skimmed into the trough 144 by raising the fluid level to 157. Light particles 153 will exit through outlet pipe 148.

After the skim cycle is completed the liquid/gas interface is lowered to level 156 and normal operating is resumed. The separation process will not be interrupted during the skim cycle.

FIG. 16 shows a variant of the sixth embodiment of the present invention. The operating principle is the same. Instead of the fixed surface collecting plates 145 there are plates 165 that create an enclosure for gas underneath. The liquid/gas interface then becomes the particle collecting surface. As particles accumulate they will be released at the inner edge and float to the surface. The skim process to remove the light particles is the same as for FIG. 15.

The methods and embodiments of apparatus described above will work for fluids having a wide range of submerged particle content in the bulk fluid.

The separation process can be further enhanced by injecting gas and/or chemicals to the incoming fluid.

Thus, the reader will see that separation of submerged particles from a fluid of the invention provides a highly reliable, easy to operate, easy to fabricate, economical solution. While the above description contains many specifics, these should not be construed as limitations on the scope of the invention, but rather as an exemplification of a few preferred embodiments thereof. Many other variations are possible, for example in the shape of a square, rectangular or spherical design. Accordingly, the scope of the invention should be determined not by the embodiments illustrated, but by the appended claims and their legal equivalents.

### REFERENCE NUMERALS IN DRAWINGS

Numbers refer to FIGS. 1, 2, 3 and 4

| No | Description |
|---|---|
| 1 | Inlet fluid |
| 2 | Treated fluid |
| 3 | Light particles out |
| 4 | Heavy particles out |
| 5 | Liquid/gas interface |
| 6 | |
| 7 | |
| 8 | Vessel wall |
| 9 | Top enclosure |
| 10 | Inlet pipe |
| 11 | Inlet champer |
| 12 | Flow distribution apertures |
| 13 | Guide for flow |
| 14 | Particle trap |
| 15 | Particle outlet pipe |
| 16 | Bottom enclosure |
| 17 | Cup for heavy particles |
| 18 | Main fluid outlet pipe |
| 19 | Heavy particles outlet pipe |

Numbers refer to FIGS. 5 and 6

| No | Description |
|---|---|
| 20 | Vessel |
| 21 | Inlet pipe |
| 22 | Flow diverter plate |
| 23 | Flow distribution apertures |
| 24 | Chamber - cylindrical wall |
| 25 | Chamber - top enclosure |
| 26 | Vortex breaker |
| 27 | Main fluid outlet pipe |
| 28 | Outlet pipe for light particles |
| 29 | Outlet pipe for light particles |
| 30 | Outlet pipe for heavy particles |
| 31 | Inlet chamber |
| 32 | Particle trap chamber |
| 33 | Vessel top enclosure |
| 34 | Vessel bottom enclosure |
| 35 | Main fluid in |
| 36 | Treated fluid out |
| 37 | Light particles out |
| 38 | Heavy particles out |
| 39 | Liquid/gas interface |

Numbers refer to FIGS. 7, 8 and 9

| No | Description |
|---|---|
| 40 | Vessel |
| 41 | Inlet pipe |
| 42 | Flow diverter plate |
| 43 | Flow distribution apertures |
| 44 | Chamber - cylindrical section |
| 45 | Chamber - top enclosure |
| 46 | Internal chamber |
| 47 | Guide vane |
| 48 | Outlet vortex breaker |
| 49 | Treated fluid outlet pipe |
| 50 | Light particle outlet pipe |
| 51 | Heavy particle outlet pipe |
| 52 | Vessel top enclosure |
| 53 | Vessel bottom enclosure |
| 54 | Inlet chamber |
| 55 | Inlet fluid |
| 56 | Treated fluid out |
| 57 | Light particles |
| 58 | Heavy particles |
| 59 | Liquid/gas interface |

Numbers refer to FIGS. 10 and 11

| No | Description |
|---|---|
| 70 | Vessel |
| 71 | End caps |
| 72 | Particle trap |
| 73 | Inlet manifold |
| 74 | Outlet pipe |
| 75 | Light particles outlet pipe |
| 76 | Collectors |
| 77 | Outlet vortex breaker |
| 78 | Heavy particles trap |
| 79 | Heavy particles outlet pipe |
| 80 | Inlet fluid |
| 81 | Treated fluid out |
| 82 | Light particles |
| 83 | Heavy particles |
| 84 | Fluid/Gas interface |

Numbers refer to FIGS. 12 and 13

| No | Description |
|---|---|
| 101 | Vessel |
| 102 | Inlet flange |
| 103 | Expansion cone |
| 104 | Inlet vane |
| 105 | Internal concentric pipes |
| 106 | Vanes |
| 107 | Collector plate and pipe |
| 108 | Light particles collection well |
| 109 | Light particles outlet pipe |
| 110 | Heavy particles collection well |
| 111 | Heavy particles outlet pipe |
| 112 | Reducer cone |
| 113 | Outlet flange |
| 114 | Inlet fluid |
| 115 | Treated fluid out |
| 116 | Light particles |
| 117 | Heavy particles |

Numbers refer to FIG. 14

| No | Description |
|---|---|
| 120 | Vessel |
| 121 | End flange |
| 122 | Inlet pipe |
| 123 | Divider |
| 124 | Vane |
| 125 | Liquid/gas interface |
| 126 | Light particle outlet pipe |
| 127 | Heavy particle outlet pipe |
| 128 | Main fluid outlet pipe |
| 129 | Heavy particles collection well |
| 130 | Inlet fluid |
| 131 | Treated fluid out |
| 132 | Light particles |
| 133 | Heavy particles |

Numbers refer to FIG. 15

| No | Description |
|---|---|
| 140 | Cylindrical Vessel |
| 141 | Inlet pipe |
| 142 | Inlet chamber |
| 143 | Flow distribution apertures |
| 144 | Particle skim trough |
| 145 | Collector plate |
| 146 | Diverter plate |
| 147 | Treated fluid outlet pipe |
| 148 | Light particles outlet pipe |
| 149 | Gas particles outlet pipe |
| 150 | Heavy particles outlet pipe |
| 151 | Inlet fluid |
| 152 | Treated fluid |
| 153 | Light particles |
| 154 | Gas particles |
| 155 | Heavy particles |
| 156 | Normal fluid level |
| 157 | Skim level |

Numbers refer to FIG. 16

| No | Description |
|---|---|
| 160 | Cylindrical Vessel |
| 161 | Inlet pipe |
| 162 | Inlet chamber |
| 163 | Flow distribution apertures |
| 164 | Particle skim trough |
| 165 | Collector plate with gas pocket |
| 166 | Diverter plate |
| 167 | Treated fluid outlet pipe |
| 168 | Light particles outlet pipe |
| 169 | Gas particles outlet pipe |
| 170 | Heavy particles outlet pipe |
| 171 | Inlet fluid |
| 172 | Treated fluid |
| 173 | Light particles |
| 174 | Gas particles |
| 175 | Heavy particles |
| 176 | Normal fluid level |
| 177 | Skim level |
| 178 | Gas/liquid interface |

1. Method for separating particles from a fluid, said particles are dispersed in the fluid and consist of lighter particles with a lower density than the bulk of the fluid, and optionally heavier particles with a density higher than the bulk of the fluid,
characterised in that the method comprises the following steps:
feeding the particle containing fluid to a separation device,
evenly distribute the fluid over at least parts of the cross-sectional area by flowing through a distribution device (12; 23; 43; 73; 104; 122; 143; 163) in an inlet chamber (11; 31; 54; 142; 162)
providing the particle containing fluid with a specific velocity and leading the fluid to one or more collecting surfaces (5; 9; 25; 33; 39; 45; 52; 59; 70; 76; 101; 105; 125; 145; 156; 157; 165; 176; 177)
coalesce the lighter particles on the collecting surface (5; 9; 25; 33; 39; 45; 52; 59; 70; 76; 101; 105; 125; 145; 156; 157; 165; 176; 177)
remove the coalesced lighter particles from the collecting surface (5; 9; 25; 33; 39; 45; 52; 59; 70; 76; 101; 105; 125; 145; 156; 157; 165; 176; 177)
remove the particle depleted fluid and the lighter coalesced particles in at least two separate streams (2; 35; 56; 81; 115; 131; 152; 172, 3; 37; 57; 82; 116; 132; 153; 173)
optionally remove the heavier particles from the bottom of the separation device in at least one separate stream (4; 38; 58; 83; 117; 133; 155; 175)

2. Method according to claim 1,
characterised in that the distribution device (12; 23; 43; 73; 104; 122; 143; 163) is a perforated plate or a perforated tube.

3. Method according to claim 1,
characterised in that the collecting surface (5; 9; 25; 33; 39; 45; 52; 59; 70; 76; 101; 105; 125; 145; 156; 157; 165; 176; 177) is one or more solid surfaces, one or more gas/liquid interfaces or combinations thereof.

4. Method according to claim 1,
characterised in that the specific velocity of the particle containing fluid is in the range from 0.001 to 1 m/s relative to the collecting surface (5; 9; 25; 33; 39; 45; 52; 59; 70; 76; 101; 105; 125; 145; 156; 157; 165; 176; 177), more preferably 0.05 to 0.3 m/s.

5. Apparatus for separating particles from a fluid, said particles comprises lighter particles with a density lower than the bulk of the fluid and optionally heavier particles with a density higher than the bulk of the fluid, said apparatus comprising a vessel with at least one inlet (10; 21; 41; 73; 102; 122; 141; 161) for the fluid to be separated, at least one outlet (18; 27; 49; 74; 113; 128; 147; 167) for particle depleted fluid, and at least one outlet (15; 28; 29; 50; 75; 109; 126; 148; 168) for separated lighter particles and optionally at least one outlet for heavier particles (19; 30; 51; 79; 111; 127; 150; 170),
characterised in that the apparatus further comprises:
distribution device (12; 23; 43; 73; 104; 122; 143; 163) for distributing the fluid evenly over at least parts of the cross-sectional area,
one or more collecting surfaces (5; 9; 25; 33; 39; 45; 52; 59; 70; 76; 101; 105; 125; 145; 156; 157; 165; 176; 177) for collecting and coalescing particles from the fluid.

6. Apparatus according to claim 5,
characterised in that said distribution device (12; 23; 43; 73; 104; 122; 143; 163) comprises a plate with through going apertures, a perforated tube or one or more flow directing tubes, through which the fluid passes.

7. Apparatus according to claim 5,
characterised in that the collecting surfaces (5; 9; 25; 33; 39; 45; 52; 59; 70; 76; 101; 105; 125; 145; 156; 157; 165; 176; 177) are one or more solid surfaces, one or more gas/liquid interfaces or combinations thereof.

8. Apparatus according to claim 5,
characterised in that said apparatus comprises at least one collecting surface (5; 9; 25; 39; 45; 59), and an inlet chamber (11; 31; 54) connected to said at least one inlet (10; 21; 41), said inlet chamber is provided with a plate (12; 23; 43) with through-going apertures or one or more flow directing tubes, through which said fluid passes and being evenly distributed over at least a part of the cross-sectional area of the apparatus, and optionally guiding means (13) for guiding the flow of fluid towards said collecting surfaces (5; 9; 25; 39; 45; 59).

9. Apparatus according to claim 5,
characterised in that said vessel a generally circular cross-section and comprises a vertical, generally cylindrical sidewall (8), a vessel top (9) and a vessel bottom (16), said vessel top (9), a gas/liquid interface (5) or combinations thereof, constitutes the collecting surface, said vessel top (9) comprises a particle trap comprising a cylindrical cap (14) in which said outlet (15) is provided.

10. Apparatus according to claim 5
characterised in that said collecting surface comprises at least one internal cap with a generally vertical, cylindrical section (24; 44) with a top enclosure (25; 45) and a smaller, cylindrical cap at the top centre of the top enclosure (25; 45), said outlet (27; 49) comprises a generally cylindrical part which projects into the vessel and into which cylindrical part the cylindrical cap projects, that an outlet tube (28; 50) for separated lighter particles is connected to the cylindrical cap and projects out through the cylindrical part, that the upper part of the vessel, above the top enclosure comprises a chamber with a particle outlet tube (28; 50) and optionally with an outlet vortex breaker (26; 48).

11. Apparatus according to claim 10,
characterised in that the apparatus comprises several internal chambers (46) placed vertically above each other, and that each chamber is provided with a separate particle outlet tube (50), and the apparatus further comprises several circular vanes (47) mounted inside the vessel's cylindrical part, between each of the chambers (46), said circular vanes (47) has a large circular opening in the centre.

12. Apparatus according to claim 5,
characterised in that the apparatus comprises a substantially horizontal, elongated, mainly cylindrical vessel (70; 101; 120) with one or more collecting surfaces, where the main collecting surface is the gas/liquid interface, the internal upper part of the vessel (70; 101; 120) and additionally either one or more substantially horizontal superimposed plates (76) or at least one, preferable more substantially horizontal concentric pipes (105).

13. Apparatus according to claim 12,
characterised in that said inlet device comprises an inlet manifold (73) with several apertures for distributing the fluid to be separated into the vessel (70), said inlet manifold (73) is constituted of a tube which runs substantially parallel with the horizontal axis of the vessel (70).

14. Apparatus according to claim 12,
characterised in that the cylindrical vessel (101) has an inlet (102) for fluid to be separated at one end and an outlet (113) for separated fluid at the other end, that the inlet device comprises an expansion cone (103) and an inlet vane (104) adjacent the inlet (102) to distribute the fluid to be treated, that the collecting surfaces consist of the gas/liquid interface and/or the inside upper half of the vessel (101) and at least two concentric tubes (105) with angular vanes (106) in order to provide the fluid with a rotational movement, and that the vessel (101) has an outlet (109) for the removal of light particles and an outlet (111) for the removal of heavier particles.

15. Apparatus according to claim 14,
characterised in that the longitudinal axis of the cylindrical vessel (101) is angular in relation to the horizontal axis, resulting in that the level of the outlet (113) is higher than the level of the inlet (102).

16. Apparatus according to claim 5,
characterised in that the collecting surfaces are a combination of several solid surfaces (144, 145; 164, 165) and one or more gas/liquid interfaces (156, 157; 176, 177, 178), said solid surfaces (144, 145; 164, 165) are annular and that some of the annular solid surfaces (145; 165) are superimposed with a mutual vertical spacing and have an outer diameter which is less than the inner diameter of the vessel (140; 160), where the cross-section of the collecting surfaces has a truncated cone form or an inverted V-form.

17. Method according to claim 2,
characterised in that the collecting surface (5; 9; 25; 33; 39; 45; 52; 59; 70; 76; 101; 105; 125; 145; 156; 157; 165; 176; 177) is one or more solid surfaces, one or more gas/liquid interfaces or combinations thereof.

18. Apparatus according to claim 6,
characterised in that said vessel a generally circular cross-section and comprises a vertical, generally cylindrical sidewall (8), a vessel top (9) and a vessel bottom (16), said vessel top (9), a gas/liquid interface (5) or combinations thereof, constitutes the collecting surface, said vessel top (9) comprises a particle trap comprising a cylindrical cap (14) in which said outlet (15) is provided.

19. Apparatus according to claim 7,
characterised in that said vessel a generally circular cross-section and comprises a vertical, generally cylindrical sidewall (8), a vessel top (9) and a vessel bottom (16), said vessel top (9), a gas/liquid interface (5) or combinations thereof, constitutes the collecting surface, said vessel top (9) comprises a particle trap comprising a cylindrical cap (14) in which said outlet (15) is provided.

20. Apparatus according to claim 8,
characterised in that said vessel a generally circular cross-section and comprises a vertical, generally cylindrical sidewall (8), a vessel top (9) and a vessel bottom (16), said vessel top (9), a gas/liquid interface (5) or combinations thereof, constitutes the collecting surface, said vessel top (9) comprises a particle trap comprising a cylindrical cap (14) in which said outlet (15) is provided.
